(19) United States
(12) Patent Application Publication
(10) Pub. No.: US 2024/0043036 A1
(43) Pub. Date: Feb. 8, 2024

(54) AUGMENTED CAPABILITIES FOR AUTOMOTIVE APPLICATIONS

(71) Applicant: ZENUITY AB, Göteborg (SE)

(72) Inventors: Magnus GYLLENHAMMAR, Pixbo (SE); Carl ZANDÉN, Lindome (SE); Majid KHORSAND VAKILZADEH, Mölndal (SE)

(21) Appl. No.: 18/254,419

(22) PCT Filed: Nov. 26, 2020
(86) PCT No.: PCT/EP2020/083538

§ 371 Date: May 25, 2023

(51) Int. Cl. B60W 60/00; B60W 40/02; B60W 50/00

(52) U.S. Cl. CPC B60W 60/0011; B60W 60/0053; B60W 40/02; B60W 50/00; B60W 2050/0005; B60W 2556/20; B60W 2556/35; B60W 2556/45

(57) ABSTRACT

The present disclosure relates to a method for augmenting capabilities of an Automated Driving System (ADS) of a vehicle. The method includes locally processing, by means of a perception module of the ADS, sensor data obtained from one or more sensors of the vehicle in order to generate a local world-view of the ADS, wherein the sensor data includes information about a surrounding environment of the vehicle. The method further includes transmitting sensor data including information about the surrounding environment of the vehicle to a remote system, and receiving off-board processed data from the remote system, the off-board processed data being indicative of a supplementary world-view of the ADS. Furthermore, the method includes forming an augmented world-view of the ADS based on the generated local world-view and the supplementary world-view.

### TECHNICAL FIELD

The present invention relates to Automated Driving Systems (ADSs) of automotive vehicles. More specifically, the present invention relates to methods and systems for augmenting capabilities of an Automated Driving System (ADS) of a vehicle.

### BACKGROUND

During the last few years, the research and development activities related to autonomous vehicles has exploded in number and many different approaches are being explored. An increasing portion of modern vehicles have advanced driver-assistance systems (ADAS) to increase vehicle safety and more generally road safety. ADAS—which for instance may be represented by adaptive cruise control, ACC, collision avoidance system, forward collision warning, etc.—are electronic systems that may aid a vehicle driver while driving. Today, there is ongoing research and development within a number of technical areas associated to both the ADAS and Autonomous Driving (AD) field. ADAS and AD will herein be referred to under the common term Automated Driving System (ADS) corresponding to all of the different levels of automation as for example defined by the SAE J3016 levels (0-5) of driving automation, and in particular for level 4 and 5.

In a not too distant future, ADS solutions are expected to have found their way into a majority of the new cars being put on the market. An ADS may be construed as a complex combination of various components that can be defined as systems where perception, decision making, and operation of the vehicle are performed by electronics and machinery instead of a human driver, and as introduction of automation into road traffic. This includes handling of the vehicle, destination, as well as awareness of surroundings. While the automated system has control over the vehicle, it allows the human operator to leave all or at least some responsibilities to the system. An ADS commonly combines a variety of sensors to perceive the vehicle's surroundings, such as e.g. radar, LIDAR, sonar, camera, navigation system e.g. GPS, odometer and/or inertial measurement units (IMUS), upon which advanced control systems may interpret sensory information to identify appropriate navigation paths, as well as obstacles, free-space areas, and/or relevant signage.

A problem within the field of automated driving systems is the growing need of processing capability to construct a sufficiently rich representation of the surrounding environment of the vehicle and then plan accordingly. More specifically, the limitation invoked by the available hardware and power resources onboard the vehicle imposes direct limitations on (1) the amount of input data (e.g. raw sensor data) that can effectively be utilized, and (2) on the level of sophistication of the algorithms (including neural networks) responsible for the perception output. This in turn limits the number of extensions or new functionality that can be added to an existing platform which is already at its capability limit.

There is accordingly a need in the art for new solutions for handling a growing processing need in order to build better awareness of the vehicle's surroundings. As always, the improvement in performance and extension of functionality shall preferably be made without significant impact on the size, power consumption and cost of the on-board system or platform.

### SUMMARY

It is therefore an object of the present invention to provide a method for augmenting capabilities of an ADS of a vehicle, a computer-readable storage medium, a corresponding in-vehicle system, and a vehicle comprising such a system which alleviates all or at least some of the drawbacks associated with currently known systems.

In particular it is an object of the present disclosure to provide a solution for handling the growing computational need and data availability for improving the representation of the vehicle's surroundings with minimal impact on size, power consumption and cost of the on-board system or platform.

These and other objects are achieved by means of a method for augmenting capabilities of an ADS of a vehicle, a computer-readable storage medium, a corresponding in-vehicle system, and a vehicle comprising such a system as defined in the appended claims. The term exemplary is in the present context to be understood as serving as an instance, example or illustration.

According to a first aspect of the present invention, there is provided a method for augmenting capabilities of an ADS of a vehicle. The method comprises locally processing, by means of a perception module of the ADS, sensor data obtained from one or more sensors of the vehicle in order to generate a local world-view of the ADS, wherein the sensor data comprises information about a surrounding environment of the vehicle. The method further comprises transmitting sensor data comprising information about the surrounding environment of the vehicle to a remote system and receiving off-board processed data from the remote system, the off-board processed data being indicative of a supplementary world-view of the ADS. Furthermore, the method comprises forming an augmented world-view of the ADS based on the generated local world-view and the supplementary world-view, and generating (106), at an output, a signal indicative of the augmented world-view of the ADS.

Accordingly, the present inventors realized that in order to control the ADS in a safe way it is in the majority of cases sufficient to obtain this output from the perception system within the order of hundreds of milliseconds or even seconds (as most of safety is done through precautionary algorithms, and not quick emergency actions). This acceptable delay opens up for the opportunity to conduct some (rather large parts) of the processing (for both real-time perception and decision & control, as well as supervision of these) in a cloud service/system. Moving to cloud processing for real-time control has several technical advantages related to the increased flexibility achieved when the algorithms and models used are decoupled from the on-board platform.

Further, according to a second aspect of the present invention, there is provided a (non-transitory) computer-readable storage medium storing one or more programs configured to be executed by one or more processors of a vehicle control system, the one or more programs comprising instructions for performing the method according to any one of the embodiments disclosed herein. With this aspect of the invention, similar advantages and preferred features are present as in the previously discussed first aspect of the invention.

The term “non-transitory,” as used herein, is intended to describe a computer-readable storage medium (or “memory”) excluding propagating electromagnetic signals, but are not intended to otherwise limit the type of physical computer-readable storage device that is encompassed by the phrase computer-readable medium or memory. For instance, the terms “non-transitory computer readable medium” or “tangible memory” are intended to encompass types of storage devices that do not necessarily store information permanently, including for example, random access memory (RAM). Program instructions and data stored on a tangible computer-accessible storage medium in non-transitory form may further be transmitted by transmission media or signals such as electrical, electromagnetic, or digital signals, which may be conveyed via a communication medium such as a network and/or a wireless link. Thus, the term “non-transitory”, as used herein, is a limitation of the medium itself (i.e., tangible, not a signal) as opposed to a limitation on data storage persistency (e.g., RAM vs. ROM).

Further, according to another aspect of the present invention, there is provided an in-vehicle system for augmenting capabilities of an ADS of a vehicle. The in-vehicle system comprises control circuitry configured to locally process, by means of a perception module, sensor data obtained from one or more sensors of the vehicle in order to generate a local world-view of the ADS. The sensor data comprises information about a surrounding environment of the vehicle. The control circuitry is further configured to transmit sensor data comprising information about the surrounding environment of the vehicle to a remote system, and obtain off-board processed data from the remote system. The off-board processed data is indicative of a supplementary world-view of the ADS. Furthermore, the control circuitry is configured to form an augmented world-view of the ADS based on the generated local world-view and the supplementary world-view, and generate, at an output, a signal indicative of the augmented world-view of the ADS. With this aspect of the invention, similar advantages and preferred features are present as in the previously discussed first aspect of the invention.

Still further in accordance with another aspect of the present invention there is provided a ground vehicle comprising at least one sensor configured to monitor a surrounding environment of the vehicle, at least one communication device for transmitting/receiving wireless signals to/from a remote system via a communication network, and an in-vehicle system according to any one of the embodiments disclosed herein.

Further embodiments of the invention are defined in the dependent claims. It should be emphasized that the term “comprises/comprising” when used in this specification is taken to specify the presence of stated features, integers, steps, or components. It does not preclude the presence or addition of one or more other features, integers, steps, components, or groups thereof.

These and other features and advantages of the present invention will in the following be further clarified with reference to the embodiments described hereinafter.

### BRIEF DESCRIPTION OF THE DRAWINGS

Further objects, features and advantages of embodiments of the invention will appear from the following detailed description, reference being made to the accompanying drawings, in which:

FIG. 1 is a schematic flow chart of a method for augmenting capabilities of an Automated Driving System (ADS) of a vehicle in accordance with some embodiments.

FIG. 2 is a schematic block diagram of an in-vehicle system for augmenting capabilities of an Automated Driving System (ADS) of a vehicle in accordance with some embodiments.

FIG. 3 is a schematic block diagram of an in-vehicle system for augmenting capabilities of an Automated Driving System (ADS) of a vehicle in accordance with some embodiments.

FIG. 4 is a schematic block diagram of an in-vehicle system for augmenting capabilities of an Automated Driving System (ADS) of a vehicle in accordance with some embodiments.

FIG. 5 is a schematic block diagram of an in-vehicle system for augmenting capabilities of an Automated Driving System (ADS) of a vehicle in accordance with some embodiments.

FIG. 6 is a schematic side view of a vehicle comprising an in-vehicle system for augmenting capabilities of an Automated Driving System (ADS) of a vehicle in accordance with some embodiments.

### DETAILED DESCRIPTION

Those skilled in the art will appreciate that the steps, services and functions explained herein may be implemented using individual hardware circuitry, using software functioning in conjunction with a programmed microprocessor or general purpose computer, using one or more Application Specific Integrated Circuits (ASICs) and/or using one or more Digital Signal Processors (DSPs). It will also be appreciated that when the present invention is described in terms of a method, it may also be embodied in one or more processors and one or more memories coupled to the one or more processors, wherein the one or more memories store one or more programs that perform the steps, services and functions disclosed herein when executed by the one or more processors.

In the following description of exemplary embodiments, the same reference numerals denote the same or similar components.

To control an ADS in a safe way it is, for a relatively large amount of scenarios or cases, sufficient to obtain the output from the perception system within the order of hundreds of milliseconds or even seconds. This is however based on the assumption that most safety related actions are and will be done through precautionary algorithms, and not quick emergency actions. This acceptable “delay” opens up for the opportunity to conduct some, or perhaps even rather large parts, of the processing in a cloud service/system, as proposed in at least some of the embodiments disclosed herein. The processing that may be performed by the cloud service includes real-time perception, Decision and Control, as well as supervision of these.

Moving to cloud processing for real-time control has several technical advantages related to the increased flexibility that is achieved when the algorithms and models used for e.g. real-time perception, Decision and Control, and/or supervision, are decoupled from the on-board platform. Some of these potential technical advantages are:
Extended capabilities beyond deployed on-board hardware (HW) platform. Moreover, the addition of new functionality or updates to the software may be rolled out more efficiently.
Added functionalities based on machine learning are no longer limited to the on-board processing hardware.
Restrictions related to the amount of training data that can be used due to potential saturation of machine learning networks may be reduced or even completely lifted.
The added functionality provided by the cloud service may be used both for Quality Management (QM) comfort control actions, as well as precautionary safety to determine safe actions in new situations, or to set more/less conservative margins of in-vehicle limits. Thus, both the user-perceived comfort as well as the general safety of the ADS may be increased.
Reduced costs related to processing resources in cloud services as compared to on-board hardware. Furthermore, processing hardware is utilized more efficiently as cloud resources are only needed for the vehicles that are currently in use (i.e. that are currently driving) as compared to on-board hardware that remains unused in parked vehicles.

It should be noted that for certain safety aspects (emergency actions and other actions that require quicker response times) in which time delay is critical, e.g. less than 10 ms, it is necessary to keep the safety related perception processing, decision and control processing in the car. In more detail, the ADS is configured such that a delay in the communication with the remote system doesn't jeopardize the safety of the system. Thus, if the response time from the remote system is too long (above a threshold), the on-board processing will always be able to handle safety-critical actions without awaiting the input from the remote system. In other words, the on-board system of the ADS shall always be able to perform safely on its own in cases when the connection to the off-board platform (i.e. remote system) is unavailable.

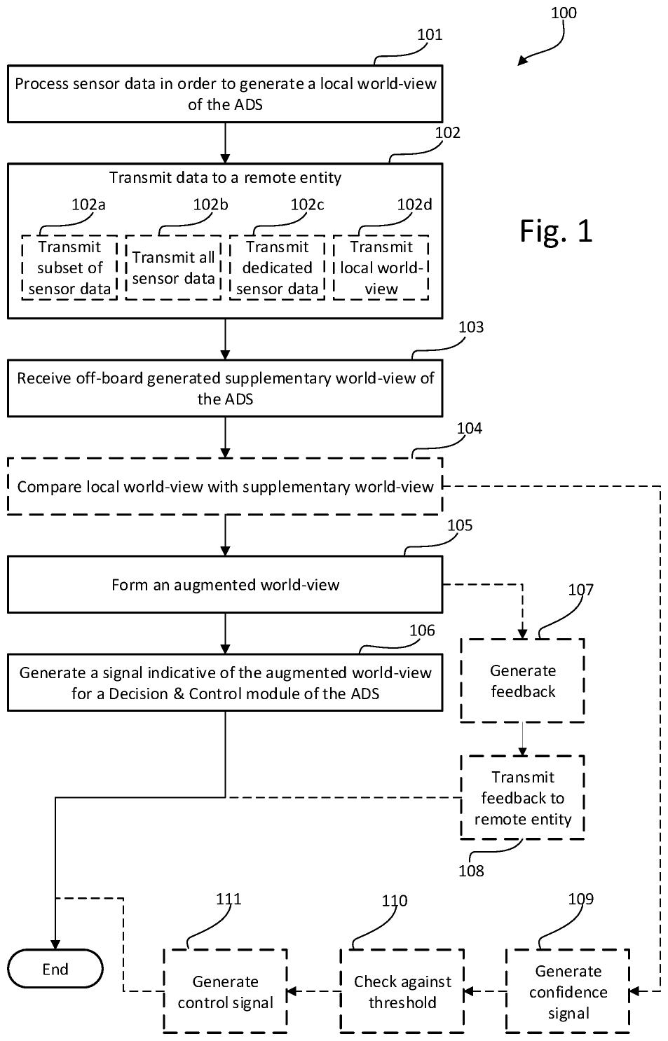

FIG. 1 is a schematic flow chart representation of a method 100 for augmenting capabilities of an ADS of a vehicle in accordance with some embodiments. A vehicle is in the presented context to be understood as a ground vehicle or road vehicle such as e.g. a car, a bus, a truck, and so forth. The term augmenting may in the present context be understood as increasing, making greater, making larger, extending, enhancing, or similar. The method 100 comprises locally processing 101, by means of a perception module of the ADS, sensor data obtained from one or more sensors of the vehicle in order to generate a local world-view of the ADS. The sensor data is associated with a time period and comprises information about the surrounding environment of the vehicle. The sensor data may for example include data generated by any suitable vehicle-mounted sensor such as radar devices, camera devices, LIDAR devices, ultrasonic devices, and so forth. The “world-view” of the ADS may be understood as the perceived reality, model of the perceived reality, or a data representation of the surroundings of the ADS using sensor data, map data, etc.

Further, the method 100 comprises transmitting 102 sensor data associated with the (same) time period and that comprises information about the surrounding environment of the vehicle to a remote system (such as e.g. a cloud processing service). In more detail, in some embodiments, the data used for generating the local world-view and the transmitted 103 sensor data originate from the same time period (i.e. have the same time stamps). This is in order to elucidate that the local perception module and the remote system processes information in the same temporal context, and to highlight the fact that remote and local processing are more or less concurrent processes.

The transmitted 102 sensor data may comprise transmitting only a subset 102a of the sensor data used for the local processing, transmitting 102b all of the sensor data used for the local processing, transmitting 102c dedicated sensor data (i.e. sensor data from one or more sensors solely dedicated to generate output for remote processing), or transmitting 102d the locally processed 101 data to the remote system. These various alternative transmissions 102a-102d are elaborated upon in the following.

Thus, in accordance with some embodiments, the step of transmitting 102 sensor data comprises transmitting 102a a subset of the sensor data obtained from the one or more sensor of the vehicle such that the supplementary world-view is based on a subset of the sensor data used for the local processing. In more detail, not all sensor data is necessarily processed by the remote system. In some cases, it might be suitable that only a subset of all the sensor data be processed off-board. For example, the image (or possibly stream of images) from one camera could be sent to the remote system whereas the rest of the sensor data (from multiple cameras, radar device(s), LIDAR device(s), etc.) is still locally processed 101 on-board by the perception module/system of the ADS.

Further, in some embodiments, the sensor data used for the local processing 101 comprises a first data stream from the one or more sensors of the vehicle, where the first data stream has a first sample rate. Moreover, the transmitted 102 sensor data then comprises a second data stream from the one or more sensors, where the second data stream has a second sample rate lower than the first sample rate. For example, the sensor data used for the local processing 101 may comprise a first image stream (having a first frame rate) from a camera device of the vehicle, while the transmitted 102 sensor data comprises a second image stream (having a second frame rate) from the camera device. In this case, the second frame rate is lower than the first frame rate. In other words, that the transmitted sensor data may in some embodiments include only every N'th image (N>=2) of the video stream used by the on-board (i.e. local) processing system. It should be noted that other types of sensor data (e.g. LIDAR output, radar output) may be used in an analogous manner.

Since the remote system may be configured with more advanced and sophisticated algorithms with more processing power, it may not be necessary to transmit 102 all of the sensor data generated on-board the vehicle in order to obtain an adequate output from the remote system. In other words, the remote system may be capable of generating high quality perception output with only a fraction of the sensor data used by the on-board perception module, thereby saving bandwidth while still having the advantages provided by the supplementary world-view.

In accordance with some embodiments, the transmitted 102 sensor data is from one or more sensors of the vehicle configured to only collect data for transmission 102c to the remote system such that the remotely generated supplementary world-view is based on a different set of sensor data than the locally generated world-view. In more detail, it is envisioned that vehicles may be produced and equipped with a higher number of sensors or more sophisticated sensors capable of outputting more data than the on-board perception system can process (e.g. due to limitations in the hardware resources). The reason for this may either be to increase redundancy or to facilitate future hardware/software upgrades on the on-board perception processing platform. Accordingly, by means of the herein disclosed solution, such sensors, that are currently are not utilized or at least not to their full extent, may be repurposed and better utilized by transmitting their output to the remote system. Moreover, in some cases, using sensor data from a “dedicated sensor”, retrofitting of existing vehicle platforms may be facilitated, for example by addition of new sensors solely for the purpose of providing remote processing capability.

In more detail, with the knowledge of remote processing (e.g. cloud processing) being available, one may add additional sensors or re-purpose existing sensors, whose output would not be possible to accommodate within the on-board processing platform. These sensors may accordingly be configured to directly stream its data to the remote system, which is configured to return useful output in a timely manner. In accordance with an illustrative example, the ADS may comprise a Traffic Jam Pilot (TJP) feature without the possibility of doing lane changes wherefore the vehicle does not have rear and side-facing LIDAR devices. However, as a development of this TJP feature, one may wish to add the capability of doing lane changes, which would require the rear and side-facing LIDAR devices.

However, the compute platform of the on-board system may not even be able to handle the addition of further data output such as the sensor output from these LIDAR devices and still be able to process the output from all of the original sensors. Accordingly, as a solution one may choose to send the image stream from one or several of the cameras to the remote system for processing and thereby free up resources in the on-board platform. In such a way, it may be possible to retrofit the platform with new sensors without necessarily warranting a hardware upgrade of the computational resources on-board platform. Thereby readily providing advantages in terms of cost-effective “retrofitting” for new functionality, improved system flexibility, and prolonged lifetime of the on-board hardware platform.

Further, in some embodiments, the locally processed 101 data is sent to the remote system. In other words, the method 100 may further comprise transmitting 102d one or more of object-level data originating from at least one sensor of the vehicle, fused object-level data from a plurality of data sources the generated local world-view of the ADS to the remote system.

Moving on, the method 100 further comprises receiving 103 off-board processed data from the remote system. The off-board processed data comprises a supplementary world-view of the ADS. In more detail, the remote system (e.g. cloud service) processes the transmitted 102 sensor data in order to generate a perception output representative of the surrounding environment of the vehicle. This remotely generated perception output is subsequently transmitted back to the vehicle where it is received as a “supplementary” world-view of the ADS.

Further, the method 100 comprises forming 105 an augmented world-view of the ADS based on the generated local world-view and the supplementary world-view. In some embodiments, the step of forming 105 the augmented world-view comprises locally processing, by means of the perception module of the ADS, the received off-board processed data in order to augment the local world-view of the ADS. In other words, the off-board processed data is received as input to the perception module of the ADS. The off-board processed data may for example be object-level data comprising data indicative of a pose of detected and classified objects or information related to other perceivable aspects (such as e.g. free-space, environmental parameters, road surface parameters, signage semantics, etc.) in the surrounding environment of the vehicle.

In some embodiments, the step of forming 105 the augmented world-view comprises combining the supplementary world-view with the generated local world-view of the ADS. Thus, the local perception output and the remotely processed data may be provided as input to a suitable perception arbitration or fusion module that is configured to combine the local world-view and the supplementary world-view to form the augmented world-view.

Further, the method 100 comprises generating 106, at an output, a signal indicative of the augmented world-view of the ADS. The signal indicative of the augmented world-view may for example be transmitted to a decision and control module of the ADS in order to control one or more actuators of the vehicle (e.g. acceleration, deceleration, steering, and so forth). In other words, once the augmented world-view of the ADS is formed 105, the ADS is configured to use this as a representation of the surrounding environment and act accordingly.

There are multiple parts of an ADS that are restrained by the platform (hardware and available power supply) of the on-board system. This means that a lot of effort is spent on developing algorithms that solve the problem related to driving and scene understanding given these hardware restrictions. Modern machine learning algorithms are fairly capable for inference (e.g. classifying an image), but real-time capability is limited by the available computational resources. Since the platform on-board an ADS is limited in computational resources, the complexity of the algorithms (e.g. size of the neural networks) are also limited in the trade-off between available resources and the requirements to provide output in real-time. As more data becomes available for algorithm development, it is of course possible to develop even more capable algorithms/models. However, since the HW platform of the ADS will be set, it may in general be practically impossible to increase the computational capacity on-board. New algorithm developments might thus be infeasible to deploy on-board vehicles due to computational restrictions.

In more detail, neural network design and size are limited by the platform they are deployed on. This means that when such models are deployed in a car with a fixed hardware platform there will be limitations in how complex the networks can be. Moreover, there is a limit on what a neural network of a given size can learn before it saturates, i.e. cannot learn any more. For such a limited neural network there is an additional challenge in selecting a set of appropriate training data that is relevant for the network to handle, without saturating it.

Thus, if one realizes, at a later stage, that the initial training data was insufficient, and that a more complex network is needed in order to handle an extended training data set, the hardware platform limitations may make it infeasible to deploy the required models. However, if the network inference task is instead performed on data (e.g. images) sent to a separate, more powerful and extendable compute platform, i.e. to a remote system such as e.g. a cloud service, the on-board hardware limitations may be circumvented for many tasks, allowing for a much higher fidelity and complexity in the deployed models and algorithms. An additional advantage of having for ADS software (such as e.g. perception processing) deployed centrally on a “cloud platform” is that decisions and planning based on interactions between multiple vehicles may be performed without having to transfer data between individual vehicles.

Further, modern communication networks allow for sufficiently low latency for many data transfer problems that require near real-time response times. With the large scale 5G roll-out expected in the coming years, it can also be assumed that high bandwidth, low-latency data transfer and communication tasks will be even easier to develop and deploy over time. Thus, the present inventors realized that conventional notions and assumptions that all of the software processing of an ADS must be performed locally on-board the vehicle may be invalid. Accordingly, it was realized that many of the quality decisions, as well as precautionary safety decisions, in a vehicle may be performed centrally (e.g. by a cloud service) and then transferred to the ADS without any noticeable impact in function performance or user experience.

Accordingly, the present invention proposes to use a remote system, such as a cloud platform, to augment the capabilities of the ADS in order to improve the perception system output. Moreover, the same concept may be extended in order to improve other ADS tasks such as path planning in accordance with some embodiments.

To allow for continuous improvement of the remote system platform (e.g. cloud platform) it is further suggested that the on-board system provides feedback as to if the remotely supplied information/data was used in the final perception output in the vehicle. Examples of why it might not have been included range from too large latency of the response from the remote system (rendering the information obsolete) to it being determined/judged not sufficiently useful. Thus, in some embodiments, the method 100 further comprises generating 107 at an output, a worldview-feedback signal for transmission to the remote system, wherein the world-view feedback signal is indicative of a level of incorporation of the off-board processed data in the augmented world-view. Moreover, the method 100 may further comprise transmitting the generated 107 feedback signal to the remote entity.

Further, the on-board system (local perception module) may use the remote system as a ground truth system to check its own output. In more detail, by for example (randomly) submitting some sensor data to the remote system, where it is processed, and then comparing the remotely produced output with the output obtained from the on-board system, it is possible to measure the accuracy or confidence level of the (limited) on-board processing platform with the (in theory unlimited) remote processing platform. This may for example be utilized in order to conduct regular checks of the on-board perception system in order to quickly detect errors or malfunctions and thereby be able to execute necessary actions in order to maintain the integrity of the ADS by for example requesting hand-over to the driver, increasing safety margins of the ADS, or the like.

Thus, in accordance with some embodiments, the method 100 further comprises comparing 104 the local world-view of the ADS with the supplementary world-view of the ADS so to determine a confidence level of the local world-view based on the comparison. Further, in some embodiments, the method 100 further comprises generating 109 at an output, a confidence signal indicative of the determined confidence level of the local world-view of the ADS.

Still further, in accordance with some embodiments, the method further comprises comparing 110 the determined confidence level of the local world-view with a confidence level threshold. If the determined confidence level is below the confidence level threshold, the method 100 may further comprise generating 111 a signal indicative of an action to be executed by a control module of the ADS, the action being at least one of a hand-over request, a dynamic driving task (DDT) fall-back, and an increase of safety margins of at least one ADS feature.

As mentioned, it can be arranged so that the remote platform has access to much more processing power compared to on-board platform, and accordingly it can be configured with more refined models for detection and prediction than the ones deployed on-board the vehicle. These more refined models can be used to, not only check the confidence levels associated with the outputs of the on-board platform, but also to reduce the level of uncertainties of the output of the on-board modules/systems. In reference to the latter, since the augmented world-view is formed based on output from these more capable algorithms. Accordingly, it may be possible to acquire more certain estimates (detections, localisation, predictions, etc.) as compared to the on-board system on its own.

Thus, with a decreased uncertainty it is subsequently possible to increase the performance of the ADS, as well as conducting potentially safer actions. This performance increase might manifest as more comfortable manoeuvres or as the ADS being able to reach its destination at a higher speed. For example, the on-board system may be capable of generating a perception output having a first level of certainty. The level of certainty may for example be in the form of an error range of ±X meters for estimations of positions and orientations of surrounding objects, predictions of object trajectories, ego-vehicle position in relation to road references, etc. Thus, in this example, this error range may be ±1 meter for the perception output of the on-board system, and the ADS is configured to operate with a certain safety margin for this error range. These safety margins may for example be manifested as maximum allowable speed of the vehicle, minimum distance to objects, etc., which limits the potential performance of the ADS. However, if the augmented perception output (i.e. the combination of the locally generated world-view and the remotely generated world-view) has a higher level of certainty, e.g. an error range of ±0.2 meters for the above-mentioned estimations, these “safety margins” invoked upon the ADS may be decreased. Thereby, the vehicle may be allowed to operate at greater speeds, and with more freedom in terms of manoeuvrability and allowable actions to be taken by the ADS. Naturally, the smaller error range or increased “certainty” of the ADS's world-view allows the ADS to act with increased safety and comfort as it may act more correctly and robustly to precautionary cues.

For example, certain manoeuvres (e.g. take-overs, lane changes, etc.) may not be possible (due to safety constraints) to be executed unless the world-view is associated with a certain confidence level. Thus, by utilizing the more powerful processing power provided by the off-board remote system, it may be possible to reach that confidence level and therefore open up for more “complex” manoeuvres, increasing, at least temporarily, the “operational scope” of the ADS.

Furthermore, in some embodiments, the on-board perception module comprises a “lean” object classification algorithm. For example, it might only be able to distinguish between cars and trucks. However, by sending every tenth image from the video stream of a camera device deployed on the vehicle (which might operate at 20 Hz) to the cloud, one might be able to increase the number of classification categories and thereby achieve a better understanding of the scene around the vehicle. Alternatively, or additionally, a trigger may activate the transmission 102 of sensor data to the remote system. The trigger may for example be a class probability score (of the on-board perception output) being below a first threshold value, or a confidence score (of the on-board perception output) being below a second threshold value. Thereby, the remote system's classification algorithm may be utilized to improve the on-board classification algorithm.

For example, the remote system may be able to detect additional classes/objects as well as further differentiate between subclasses such as e.g. different types of cars (e.g. cars with trailer, sports cars, SUVs, convertibles, sedans, station wagons, etc.) Accordingly, this may support the ADS in doing more refined driving decisions since a convertible might be much more likely to do a certain type of movements than a minivan, which are two classes that the on-board perception system might not have been able to distinguish between. Moreover, there may be at least two reasons for why one would want to include this (presumably non-safety critical) functionality in the remote system rather than the on-board platform. Firstly, it keeps the hardware cost and power consumption of the ADS platform at reduced levels, and secondly an already implemented version of the ADS hardware might not support such extended functionality. Thus, by adding it via the remote system also “old” vehicles that have this “cloud-augmentable” platform may be updated with this new functionality on demand without the need for retrofitting additional hardware. Thus, the capabilities of existing platforms may be extended in a cost effective and facilitated. In other words, advantages include reduced hardware cost for the on-board platform, improved performance and safety, lower maintenance costs, potential for increased functionality from the on-board platform hardware, and extended lifetime of the on-board hardware platform.

Accordingly, in some embodiments, the step of locally processing 101, by means of the perception module of the ADS, the sensor data from the one or more sensors of the vehicle comprises employing a detection algorithm such that the generated local world-view of the ADS comprises a first set of detected perceivable aspects. Accordingly, the supplementary world-view comprises a second set of detected perceivable aspects different from the first set of detected perceivable aspect, and the augmented world-view of the ADS comprises a combination of the first set of detected perceivable aspects and the second set of detected perceivable aspects. The set of perceivable aspects may for example be a set of predefined objects, a set of locations of free-space area, and/or a set of conditions of the surrounding environment (e.g. snow, ice, fog, etc.).

Executable instructions for performing these functions are, optionally, included in a non-transitory computer-readable storage medium or other computer program product configured for execution by one or more processors.

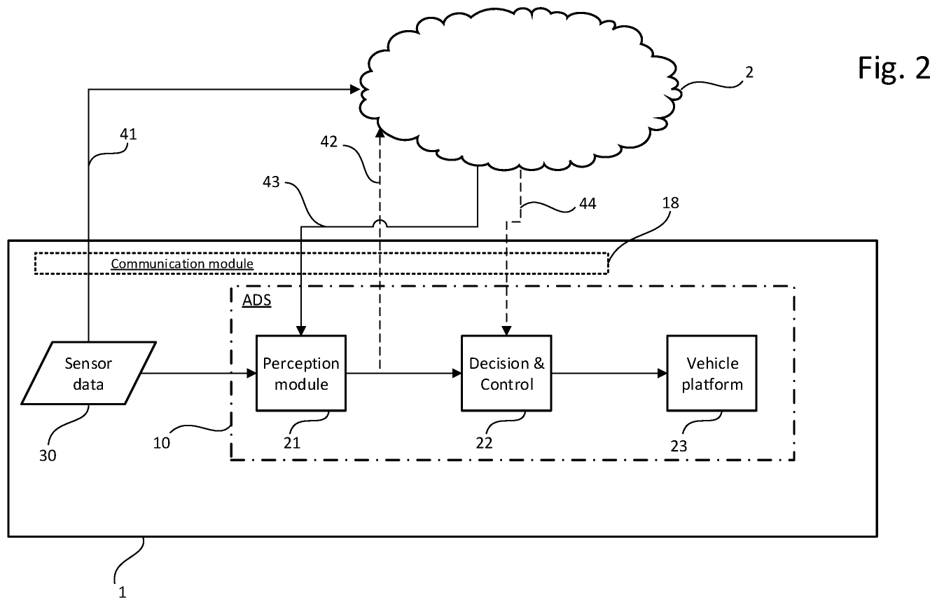

FIG. 2 is a schematic block diagram representation of an in-vehicle system 10 for augmenting capabilities of an Automated Driving System (ADS) of a vehicle 1 in accordance with some embodiments of the invention. In the illustrated embodiment, the in-vehicle system 10 is illustrated as a part of the ADS, but as the skilled reader readily understands, the in-vehicle system 10 may be provided as a separate/parallel entity depending on platform specifications or specific applications.

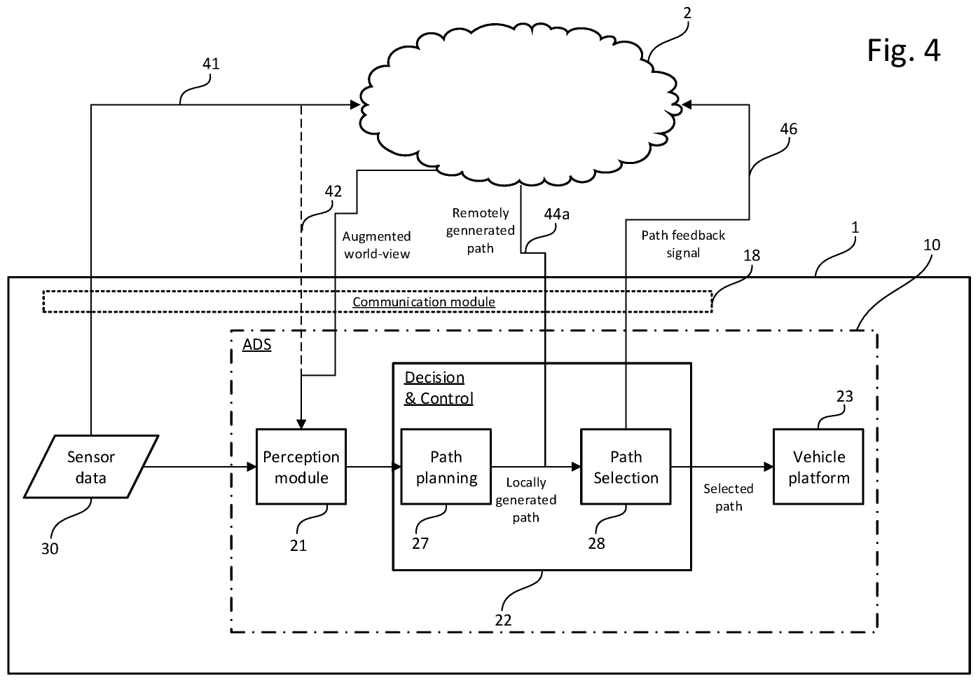

In more detail, FIG. 2 shows an overview of an example embodiment of the herein proposed system and its possible uses. The on-board system of the ADS (enclosed in the broken-line box 10) transmits data 41, 42 to the remote system 2, which processes and sends back the results 43, 44 to the on-board system 10. In some embodiments, the sensor data 30 from the vehicle 1 is transmitted to the remote system 2. In some embodiments, the transmitted data contains the perception system output 42, such as free-space, object level data, etc. Moreover, in some embodiments, the returned, remotely processed, data contains a suggested path 44 for the ADS to execute. However, these embodiments related to the remote path planning will be further elucidated in reference to FIG. 4. It should be noted that any of these depicted routes 41, 42, 43, 44 may be combined with each other in various ways and may run in parallel with each other.

Moving on, the in-vehicle system 10 comprises control circuitry configured to one or more programs stored in a computer-readable storage medium for performing the method according to any one of the embodiments disclosed herein. More specifically, in some embodiments, the control circuitry is configured to locally process, by means of a perception module 21 sensor data 30 obtained from one or more sensors of the vehicle 1 in order to generate a local world-view of the ADS. The sensor data comprises information about a surrounding environment of the vehicle. A perception system/module 21 is in the present context to be understood as a system responsible for acquiring raw sensor data 30 from on-board sensors such as cameras, LIDARs, radars, and ultrasonic sensors, and converting this raw data into scene understanding.

Further, the control circuitry is configured to transmit sensor data 30 (as indicated by the arrow/connector 41), where the sensor data 30 comprises information about the surrounding environment of the vehicle to a remote system (such as e.g. a cloud service) 2. The control circuitry 11 is further configured to obtain the off-board processed data from the remote system 2. The off-board processed data is in turn indicative of a supplementary world-view 43 of the ADS. Furthermore, the control circuitry is configured to form an augmented world-view of the ADS based on the generated local world-view and the supplementary world-view 43, and to generate, at an output, a signal indicative of the augmented world-view of the ADS. The vehicle may be provided with suitable communication circuitry 18 for transmitting and receiving signals via an external network.

The augmented world-view may for example be transmitted to a decision and control module 22 of the ADS, which is configured to generate one or more signals for controlling one or more actuators (e.g. acceleration, deceleration, steering, etc.) or other in-vehicle control systems (lighting, HMI, etc.), here represented by the vehicle platform 23, based on the obtained augmented world-view.

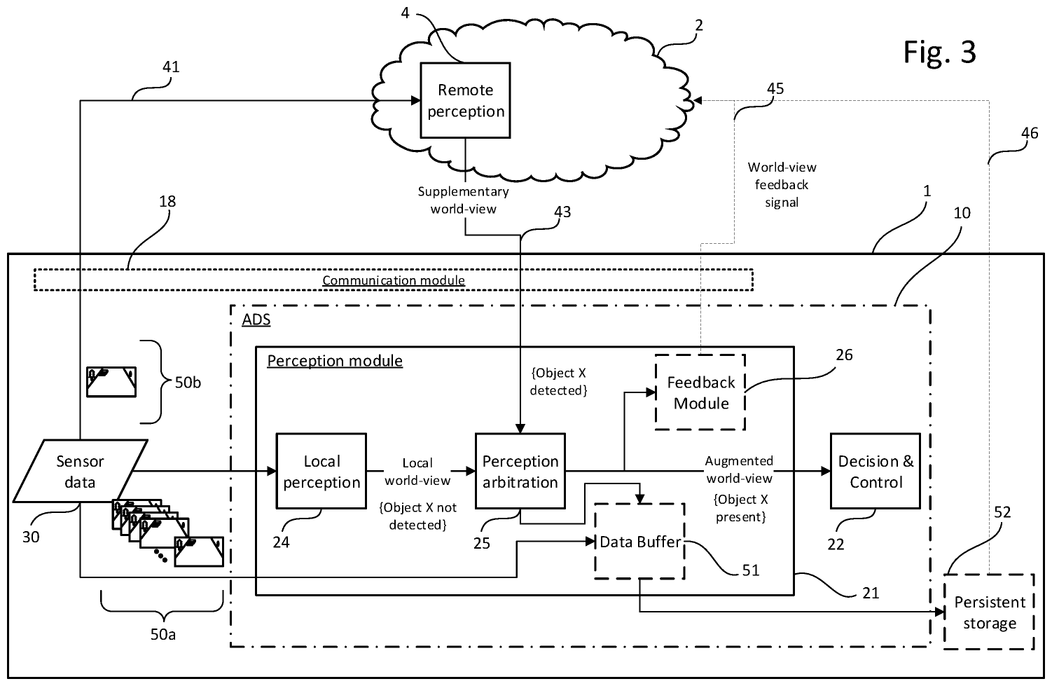

FIG. 3 is a schematic block diagram representation of an in-vehicle system 10 for augmenting capabilities of an ADS of a vehicle 1 in accordance with some embodiments of the invention. As depicted in FIG. 3, the remote system 2 is used to augment the perception data of the on-board system 10. The sensor output 30 is transmitted to the remote system 2, which returns the results 43 from processing this data 30 through potentially more complex and sophisticated algorithms on more capable hardware 4 as compared to the on-board hardware 21. The off-board processed data 43 is then incorporated in either the input to, or output from, the on-board perception block 24.

As previously mentioned, the remote system 2 may be utilized to extend the object detection/classification capabilities of the on-board perception block 24. In accordance with an illustrative example, the sensor data 30 comprises a video feed 50a from a camera. The video feed (e.g. having a frame rate of 40 Hz) is provided as input to the local perception module 21, where it is processed through an object detection and classification algorithm in order to generate a local world-view. At the same time, a subset of images from the video feed (e.g. at a frame rate of 1 Hz) is transmitted to the remote system, where it is processed through a more capable object detection and classification algorithm 4 and an output in the form of a supplementary world-view 43 is generated and sent back to the vehicle 1. It should be noted that other algorithms configured to fulfil a set of perception objectives are equally feasible.

For example, an object detection and classification algorithm of the on-board perception block 24 may not be capable of detecting specific traffic signs, or to differentiate between different types of vehicles (as previously exemplified). However, an off-board object detection and classification algorithm may be more capable, wherefore the resulting augmented world-view will be indicative of an extended object detection and classification capability, and the ADS will be provided with a better “understanding” of the surrounding environment of the vehicle.

Moreover, in some embodiments, the remote system 2 may be used to reduce uncertainty in the local perception output. In more detail, the local perception module 21 may for example not be able to detect or classify one or more objects/scenarios in the surrounding environment, or at least not to a sufficient confidence level. For example, the vehicle 1 might be approaching roadworks, but the in-vehicle network may only be able to establish that the vehicle is approaching roadworks with a 10% confidence level, which is presumably below a threshold to be accepted as true. However, the supplementary world-view does however contain a detection of roadworks ahead, with a 90% confidence level. Thus, the object that was not detectable by the on-board perception block may still be accounted for in the augmented world-view that is supplied to the decision and control block 22 of the ADS. Thus, the probability of the ADS acting on false negatives in the perception output is reduced. This not only extends the functionality of the on-board perception block 21, but also renders in a more capable ADS, thereby increasing overall road safety.

An analogous example, with a false positive, would be that the local world-view is indicating that the vehicle is approaching roadworks with e.g. a 15% confidence level, wherefore the ADS is to be deactivated (after hand-over) as it is not configured to operate autonomously in such a scenario. However, the supplementary world-view indicates that the vehicle is not approaching any roadworks, wherefore the ADS is allowed to stay operational and in control of the vehicle platform. Thus, similar advantages in terms of extended functionality are applicable for the “false positive” case.

Further, it may be advantageous to identify those scenarios where there is a discrepancy between the local world-view and the supplementary world-view so that the associated data can be used for subsequent offline analysis, training of networks, etc. Going along with the above scenario, where a perception objective (i.e. detection of roadworks) was fulfilled in the supplementary world-view and the same perception objective was not fulfilled in the local world-view, i.e. a discrepancy between the local world-view and the supplementary world-view occurred.

Thus, in some embodiments, the control circuitry of the in-vehicle system 10 is configured to locally process, by means of the perception module 21 of the ADS, the sensor data from the one or more sensors of the vehicle by employing an algorithm configured to fulfil a set of perception objectives in the local world-view of the ADS. The algorithm may in some embodiments be a detection algorithm configured to detect a predefined perceivable aspect, or a detection and classification algorithm configured to detect and classify the predefined perceivable aspect. Moreover, the predefined perceivable aspect comprises at least one of a set of predefined objects, a set of locations of free-space area, a set of conditions of the surrounding environment.

Further, the control circuitry is configured to compare the local world-view of the ADS from a specific time period with the supplementary world-view 43, of the ADS from the specific time period so to identify a discrepancy. The discrepancy is defined by a situation where the set of perception objectives are fulfilled in the supplementary world-view 43 while the set of perception objectives are not fulfilled in the local world-view of the ADS. In the illustrated embodiment, an “Object X” was detected in the transmitted sensor data 50b (with a timestamp T1) by the remote system 2, while the locally processed sensor data 50a does not comprise a sufficiently confident indication of “Object X” based on the sensor data being associated with the corresponding time stamp T1.

Further, the control circuitry is configured to temporarily store the sensor data 30 in a data buffer, the data buffer 51 having a buffer length in the range of 1 second to 300 seconds (e.g. 20 seconds, 30 seconds, 60 seconds, etc.). Accordingly, if the comparison is indicative of the discrepancy, the control circuitry is configured to transfer sensor data from the data buffer 51, the transferred sensor data comprising sensor data from the specific time period. The specific time period may for example be a time-period around the time stamp T1 associated with the sensor data where the discrepancy was formed, such as e.g. 15 seconds before and 15 seconds after T1. This provides a possibility to collect all of the sensor data generated by the on-board vehicle sensors during a time period preceding and following the moment in time where the discrepancy was formed. Thereby, the whole scenario leading up to and following the discrepancy can be analysed and properly annotated for training. Moreover, the data buffer may be of different lengths for different data categories, e.g. the road estimation filters etc. may require a longer buffer to capture the whole scenario, while target tracking may only need 7 s.

Moreover, in some embodiments, the step of transferring sensor data comprises transferring sensor data from the data buffer to a persistent storage 52. The data stored in the persistent storage may subsequently be uploaded 46 for offline analysis and annotation at a suitable time (e.g. while the vehicle 1 is parked).

It is generally rather difficult to generate or at least collect high quality training data that can be used to train a neural network, and in particular where there is an immense amount of data to review, where a majority of data is irrelevant for training purposes. In more detail, it may be an unsurmountable amount of work to manually review all of the data that a vehicle generates over the course of a driving session, and to select the data that is suitable for the training of specific neural networks. Therefore, by clever use of the situations where discrepancies between the local and supplementary world-views are identified, it is possible to extract high quality training data for machine learning purposes.

As mentioned, in order to allow for continuous improvement of the remote system's perception stack 4, the in-vehicle system 10 may comprise a feedback module configured to provide feedback 45 as to if the supplementary world-view was used in the augmented world-view. In more detail, the control circuitry of the in-vehicle system 10 may be configured to generate, at an output, a worldview-feedback signal 45 for transmission to the remote system 2, where the world-view feedback signal 45 is indicative of a level of incorporation of the off-board processed data 43 in the augmented world-view. Level of incorporation may in some embodiments be how much additional data was provided by the remote system 2 compared to on-board perception block 24, and/or how much of the supplied supplementary world-view 43 (both time instances and area) that was utilised in the augmented world-view.

FIG. 4 is a schematic block diagram representation of an in-vehicle system 10 for augmenting capabilities of an ADS of a vehicle 1 in accordance with some embodiments. Here, all of the sensor data 30 may be transmitted to the remote system 2 (as indicated by arrow/connector 41) in order to let the remote system 2 determine a suggested path (candidate path) 44a for the ADS to execute. In some embodiments however, the output 42 from the perception module 21 (e.g. object-level data) is transmitted to the remote system 2 in addition to or as an alternative for the sensor data 30.

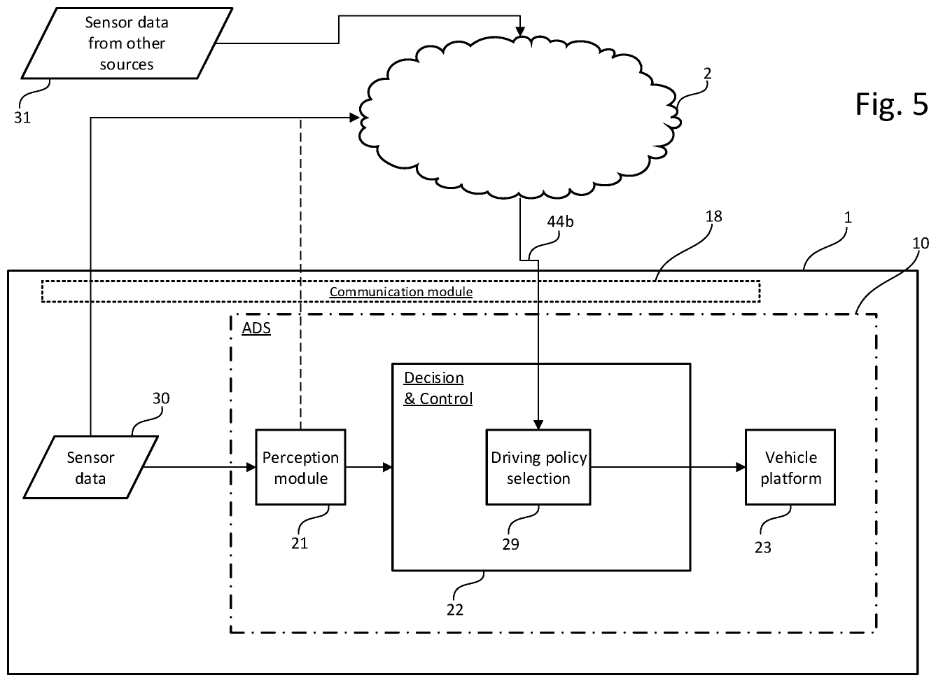

In other words, sensor data 30 is transmitted to the off-board platform 2 for processing and the new augmented data 44a is transmitted back to the ADS. Sensor data 30 may for example be raw images that are classified in a cloud network 2 and further processed by the cloud network 2. The output 44a from the cloud network 2 is then sent back and received by the vehicle's 1 ADS. The output 44a from the remote system 2 may for instance be used to set the decision and control 29 safety driving policy (e.g. detection of certain objects), or as input to path planning, which is then checked by the on-board decision and control safety monitoring algorithms. The setting of a driving policy via the remote system 2 is further elaborated upon in reference to FIG. 5.

Moving on, in accordance with some embodiments, a candidate path is locally generated by a path planning module 27 of the in-vehicle system based on the augmented world-view. In other words, the control circuitry of the in-vehicle system 10 is configured to locally generate a candidate path based on the augmented world-view of the ADS. Moreover, a remotely generated candidate path 44a is received, where the remotely generated path 44a is generated by the remote system 2 based on the supplementary world-view.

Further, the control circuitry is configured to select (e.g. by means of a path selection algorithm/module 28) one candidate path for execution by the ADS based on the locally generated candidate path, the remotely generated candidate path, and at least one predefined criterion. The at least one predefined criterion may for example be a set of safety constraints (e.g. distance to external objects, distance to road edge, etc.), a set of comfort criteria (e.g. acceleration thresholds and jerk threshold for the associated trajectory), and/or a set of constraints imposed by the vehicle platform (maximum acceleration/deceleration, maximum steering torque, turning radius, vehicle dimensions, etc.). Further, the control circuitry is configured to generate, at an output, a path signal indicative of the selected candidate path.

In accordance with some embodiments, a process flow for the path planning may be summarized as:
1. Real-time sensor data 30 is streamed to the remote system 2 with time stamps.
2. Cloud processing is conducted on the sensor data stream through a cloud architecture 2 that outputs a suggested path 44a.
3. An arbitration module 28 selects the locally generated path or the remotely generated path 44a (assuming that both are available and concurrent).

Moreover, in some embodiments, a path-feedback signal 46 is transmitted back to the remote system for learning purposes. The path feedback signal 46 may for example be indicative of the selected path, and if the remotely generated path 46 was rejected, one or more rationales or reasons as to why the remotely generated path 46 was rejected (e.g. too large latency, violation of one or more safety criteria, violation of other criteria, etc.).

FIG. 5 is a schematic block diagram representation of an in-vehicle system 10 for augmenting capabilities of an ADS of a vehicle 1 in accordance with some embodiments. In more detail, FIG. 5 depicts how an off-board system (i.e. remote system) 2 can be used to supply input to the driving policy decision of the ADS. The remote system 2 can make use of the sensor data 30 and/or perception data from the ADS to determine if there is an elevated risk exposure for the ADS at the moment. If that is the case, this may be communicated to the ADS to set it in a safer (more restrained) driving policy. The risk or risk exposure may be determined based on different measures of uncertainty of the output from the perception system of the ADS given the input sensor data, but also potentially by deploying more refined sensor models in the remote system 2 in order to determine the uncertainties of the sensor data itself.

Moreover, with restrictions to the on-board hardware the focus might be on supplying the critical functions for the operations of the ADS rather than optimising performance across all subsystems. Thus, by augmenting the system with cloud processing an advanced accurate algorithm requiring high power and processing power (presumably unavailable on-board) is utilised. The output 44b from this model can focus on intricate modelling of different risk factors of the ADS. By knowing these risk factors it may be possible to handle/navigate through in a safer manner with the on-board ADS hardware. Moreover, by identifying a higher granularity of the risk (enabled by the utilization of the remote system 2) it may possible to also refine the driving policy to achieve closer to optimal performance.

Thus, in accordance with some embodiments, the control circuitry of the in-vehicle system 10 is configured to receive, from the remote system 2, a policy signal 44b indicative of a first driving policy out of a plurality of driving policies of the ADS, wherein each driving policy comprising a set of defined operating margins of the ADS. Accordingly, the control circuitry is further configured to set the driving policy of the ADS to (in accordance with) the first driving policy.

The transmission of a policy signal 44b may be construed as a way of informing the ADS of the surrounding in a different manner than sending the data to describe (i.e. transmitting the augmented world-view). The example with the driving policy is that it is relatively “data light” way, as it could essentially be an 4-bit unsigned INT being sent by the remote system 2 (to direct the ADS into which driving policy it should employ). Thus, in comparison with data of objects or descriptions of environmental conditions that needs much more “heavy data types”, depending on fidelity, the driving policy signal 44b is a bandwidth efficient way of informing the ADS of its surrounding environment.

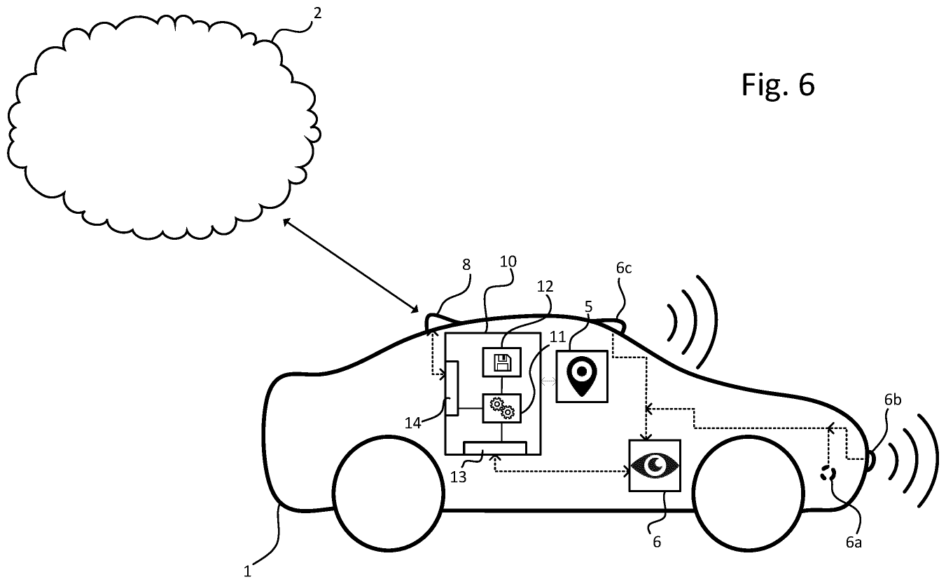

FIG. 6 is a schematic side view of a vehicle 1 comprising an in-vehicle system 10 for augmenting capabilities of an ADS of a vehicle 1 in accordance with some embodiments. The vehicle 1 further comprises a perception system 6 and a localization system 5. A perception system 6 is in the present context to be understood as a system responsible for acquiring raw sensor data from on sensors 6a, 6b, 6c such as cameras, LIDARs and radars, ultrasonic sensors, and converting this raw data into scene understanding. The localization system 5 is configured to monitor a geographical position and heading of the vehicle, and may be in the form of a Global Navigation Satellite System (GNSS), such as a GPS. However, the localization system may alternatively be realized as a Real Time Kinematics (RTK) GPS in order to improve accuracy.

The in-vehicle system 10 comprises one or more processors 11, a memory 12, a sensor interface 13 and a communication interface 14. The processor(s) 11 may also be referred to as a control circuit 11, control unit 11, controller 11, or control circuitry 11. The in-vehicle system 10 preferably comprises a number of software/hardware modules as described in the foregoing, here generalized as “control circuitry” 11. The control circuitry 11 is configured to execute instructions stored in the memory 12 to perform a method for augmenting capabilities of an ADS according to any one of the embodiments disclosed herein. Stated differently, the memory 12 of the in-vehicle system 10 can include one or more (non-transitory) computer-readable storage mediums, for storing computer-executable instructions, which, when executed by one or more computer processors 11, for example, can cause the computer processors 11 to perform the techniques described herein. The memory 12 optionally includes high-speed random access memory, such as DRAM, SRAM, DDR RAM, or other random access solid-state memory devices; and optionally includes non-volatile memory, such as one or more magnetic disk storage devices, optical disk storage devices, flash memory devices, or other non-volatile solid-state storage devices.

In more detail, control circuitry 11 is configured to locally process, by means of a perception module 6, sensor data obtained from one or more sensors 6a, 6b, 6c of the vehicle 1 in order to generate a local world-view of the ADS. The sensor data comprises information about a surrounding environment of the vehicle 1. A perception system/module 6 is in the present context to be understood as a system responsible for acquiring raw sensor data 30 from on-board sensors such as cameras, LIDARs radars, and ultrasonic sensors, and converting this raw data into scene understanding.

Further, the control circuitry 11 is configured to transmit sensor data comprising information about the surrounding environment of the vehicle to a remote system (such as e.g. a cloud service) 2. The control circuitry 11 is further configured to obtain the off-board processed data from the remote system 2. The off-board processed data is in turn indicative of a supplementary world-view of the ADS. Furthermore, the control circuitry 11 is configured to form an augmented world-view of the ADS based on the generated local world-view and the supplementary world-view, and to generate, at an output, a signal indicative of the augmented world-view of the ADS. The vehicle 1 may be provided with suitable communication means 8 for transmitting and receiving signals via an external network.

The augmented world-view may for example be transmitted to a decision and control module of the ADS, which is configured to generate one or more signals for controlling one or more actuators (e.g. acceleration, deceleration, steering, etc.) or other in-vehicle control systems (lighting, HMI, etc.), here represented by the vehicle platform, based on the obtained augmented world-view.

Further, the vehicle 1 may be connected to external network(s) via for instance a wireless link (e.g. for retrieving map data). The same or some other wireless link may be used to communicate with other vehicles in the vicinity of the vehicle or with local infrastructure elements. Cellular communication technologies may be used for long range communication such as to external networks and if the cellular communication technology used have low latency it may also be used for communication between vehicles, vehicle to vehicle (V2V), and/or vehicle to everything (V2X). Examples of cellular radio technologies are GSM, GPRS, EDGE, LTE, 5G, 5G NR, and so on, also including future cellular solutions. However, in some solutions mid to short range communication technologies are used such as Wireless Local Area (LAN), e.g. IEEE 802.11 based solutions. ETSI is working on cellular standards for vehicle communication and for instance 5G is considered as a suitable solution due to the low latency and efficient handling of high bandwidths and communication channels.

The present invention has been presented above with reference to specific embodiments. However, other embodiments than the above described are possible and within the scope of the invention. Different method steps than those described above, performing the method by hardware or software, may be provided within the scope of the invention. Thus, according to an exemplary embodiment, there is provided a non-transitory computer-readable storage medium storing one or more programs configured to be executed by one or more processors of a vehicle control system, the one or more programs comprising instructions for performing the method according to any one of the above-discussed embodiments. Alternatively, according to another exemplary embodiment a cloud computing system can be configured to perform any of the methods presented herein. The cloud computing system may comprise distributed cloud computing resources that jointly perform the methods presented herein under control of one or more computer program products.

Generally speaking, a computer-accessible medium may include any tangible or non-transitory storage media or memory media such as electronic, magnetic, or optical media—e.g., disk or CD/DVD-ROM coupled to computer system via bus. The terms “tangible” and “non-transitory,” as used herein, are intended to describe a computer-readable storage medium (or “memory”) excluding propagating electromagnetic signals, but are not intended to otherwise limit the type of physical computer-readable storage device that is encompassed by the phrase computer-readable medium or memory. For instance, the terms “non-transitory computer-readable medium” or “tangible memory” are intended to encompass types of storage devices that do not necessarily store information permanently, including for example, random access memory (RAM). Program instructions and data stored on a tangible computer-accessible storage medium in non-transitory form may further be transmitted by transmission media or signals such as electrical, electromagnetic, or digital signals, which may be conveyed via a communication medium such as a network and/or a wireless link.

The processor(s) 11 (associated with the in-vehicle control system 10) may be or include any number of hardware components for conducting data or signal processing or for executing computer code stored in memory 12. The device 10 has an associated memory 12, and the memory 12 may be one or more devices for storing data and/or computer code for completing or facilitating the various methods described in the present description. The memory may include volatile memory or non-volatile memory. The memory 12 may include database components, object code components, script components, or any other type of information structure for supporting the various activities of the present description. According to an exemplary embodiment, any distributed or local memory device may be utilized with the systems and methods of this description. According to an exemplary embodiment the memory 12 is communicably connected to the processor 11 (e.g., via a circuit or any other wired, wireless, or network connection) and includes computer code for executing one or more processes described herein.

It should be appreciated that the sensor interface 13 may also provide the possibility to acquire sensor data directly or via dedicated sensor control circuitry in the vehicle 1. The communication/antenna interface 14 may further provide the possibility to send output to a remote location (e.g. remote system) by means of the antenna 8. Moreover, some sensors 6a, 6b, 6c in the vehicle may communicate with the in-vehicle system 10 using a local network setup, such as CAN bus, I2C, Ethernet, optical fibres, and so on. The communication interface 14 may be arranged to communicate with other control functions of the vehicle and may thus be seen as control interface also; however, a separate control interface (not shown) may be provided. Local communication within the vehicle may also be of a wireless type with protocols such as WiFi, LoRa, Zigbee, Bluetooth, or similar mid/short range technologies.

It should be noted that the word “comprising” does not exclude the presence of other elements or steps than those listed and the words “a” or “an” preceding an element do not exclude the presence of a plurality of such elements. It should further be noted that any reference signs do not limit the scope of the claims, that the invention may be at least in part implemented by means of both hardware and software, and that several “means” or “units” may be represented by the same item of hardware.

Although the figures may show a specific order of method steps, the order of the steps may differ from what is depicted. In addition, two or more steps may be performed concurrently or with partial concurrence. For example, the steps of locally processing sensor data and transmitting sensor data may be interchanged based on a specific realization. Such variation will depend on the software and hardware systems chosen and on designer choice. All such variations are within the scope of the invention. Likewise, software implementations could be accomplished with standard programming techniques with rule-based logic and other logic to accomplish the various connection steps, processing steps, comparison steps and decision steps. The above mentioned and described embodiments are only given as examples and should not be limiting to the present invention. Other solutions, uses, objectives, and functions within the scope of the invention as claimed in the below described patent embodiments should be apparent for the person skilled in the art.

1. A computer-implemented method for augmenting capabilities of an Automated Driving System (ADS) of a vehicle, the method comprising:
locally processing, using a perception module of the ADS, sensor data obtained from one or more sensors of the vehicle in order to generate a local world-view of the ADS, wherein the sensor data comprises information about a surrounding environment of the vehicle;
transmitting sensor data comprising information about the surrounding environment of the vehicle to a remote system;
receiving off-board processed data from the remote system, the off-board processed data being indicative of a supplementary world-view of the ADS;
forming an augmented world-view of the ADS based on the generated local world-view and the supplementary world-view;
generating, at an output, a signal indicative of the augmented world-view of the ADS.

2. The method according to claim 1, wherein the transmitted sensor data is a subset of the sensor data obtained from the one or more sensors of the vehicle such that the supplementary world-view is based on a subset of the sensor data used for the local processing.

3. The method according to claim 2, wherein the sensor data used for the local processing comprises a first data stream from the one or more sensors of the vehicle, the first data stream having a first sample rate;
and wherein the transmitted sensor data comprises a second data stream from the one or more sensors, the second data stream having a second sample rate lower than the first sample rate.

4. The method according to claim 1, wherein the transmitted sensor data is from a sensor of the vehicle configured to only collect data for transmission to the remote system such that the supplementary world-view is based on a different set of sensor data than the local world-view.

5. The method according to claim 1, further comprising:
comparing the local world-view of the ADS with the supplementary world-view of the ADS so to determine a confidence level of the local world-view based on the comparison; and
generating, at an output, a confidence signal indicative of the determined confidence level of the local world-view of the ADS.

6. The method according to claim 5, further comprising:
comparing the determined confidence level of the local world-view with a confidence level threshold; and
if the determined confidence level is below the confidence level threshold:
generating a signal indicative of an action to be executed by a control module of the ADS, the action being one of a hand-over request, a dynamic driving task fall-back, and an increase of safety margins of at least one ADS feature.

7. The method according to claim 1, wherein locally processing, using the perception module of the ADS, the sensor data from the mean one or more sensors of the vehicle comprises employing an algorithm configured to fulfil a set of perception objectives in the local world-view of the ADS;
wherein the method further comprises:
comparing the local world-view of the ADS from a specific time period with the supplementary world-view of the ADS from the specific time period so to identify a discrepancy where the set of perception objectives are fulfilled in the supplementary world-view while the set of perception objectives are not fulfilled in the local world-view of the ADS;
temporarily storing the sensor data in a data buffer, the data buffer having a buffer length in the range of 1 second to 300 seconds; and
if the comparison is indicative of the discrepancy:
transferring sensor data from the data buffer, the transferred sensor data comprising sensor data from the specific time period,
wherein the algorithm is a detection algorithm configured to detect a predefined perceivable aspect.

8. (canceled)

9. The method according to claim 7, wherein the detection algorithm is a detection and classification algorithm configured to detect and classify the predefined perceivable aspect.

10. The method according to claim 7, wherein the predefined perceivable aspect comprises at least one of a set of predefined objects, free-space area, a set of conditions of the surrounding environment.

11. The method according to claim 7, wherein transferring sensor data comprises transferring sensor data from the data buffer to a persistent storage.

12. The method according to claim 1, wherein forming the augmented world-view comprises:
locally processing, using the perception module of the ADS, the received off-board processed data in order to augment the local world-view of the ADS; and
combining the supplementary world-view with the generated local world-view of the ADS.

13. (canceled)

14. The method according to claim 1, further comprising:
generating, at an output, a worldview-feedback signal for transmission to the remote system, wherein the world-view feedback signal is indicative of a level of incorporation of the off-board processed data in the augmented world-view.

15. The method according to claim 1, wherein the step of locally processing, using the perception module of the ADS, the sensor data from the one or more sensors of the vehicle comprises employing a detection algorithm such that the generated local world-view of the ADS comprises a first set of detected perceivable aspects,
wherein the supplementary world-view comprises a second set of detected perceivable aspects different from the first set of detected perceivable aspects, and
wherein the augmented world-view of the ADS comprises a combination of the first set of detected perceivable aspects and the second set of detected perceivable aspects.

16. The method according to claim 1, further comprising:
locally generating a candidate path based on the generated augmented world-view of the ADS;
transmitting the generated local world-view to the remote system;
receiving, from the remote system, a remotely generated candidate path, wherein the remotely generated path is generated by the remote system based on the augmented world-view of the ADS;
selecting one candidate path for execution by the ADS based on the locally generated candidate path, the remotely generated candidate path, and at least one predefined criterion; and
generating, at an output, a path signal indicative of the selected candidate path.

17. The method according to claim 1, further comprising:
locally generating a candidate path based on the generated augmented world-view of the ADS;
receiving, from the remote system, a remotely generated candidate path, wherein the remotely generated path is generated by the remote system based on the supplementary world-view of the ADS;
selecting one candidate path for execution by the ADS based on the locally generated candidate path, the remotely generated candidate path, and at least one predefined criterion; and
generating, at an output, a path signal indicative of the selected candidate path.

18. (canceled)

19. The method according to claim 16, further comprising:
generating, at an output, a path-feedback signal for transmission to the remote system, wherein the path-feedback signal is indicative of the selected candidate path.

20. The method according to claim 16, further comprising:
receiving, from the remote system, a policy signal indicative of a first driving policy out of a plurality of driving policies of the ADS, wherein each driving policy comprising a set of defined operating margins of the ADS; and
setting the driving policy of the ADS to the first driving policy.

21. A non-transitory computer-readable storage medium storing one or more programs configured to be executed by one or more processors of a vehicle control system, the one or more programs comprising instructions for performing the method according to claim 1.

22. An in-vehicle system for augmenting capabilities of an Automated Driving System (ADS) of a vehicle, the in-vehicle system comprising a control circuitry configured to:
locally process, using a perception module, sensor data obtained from one or more sensors of the vehicle in order to generate a local world-view of the ADS, wherein the sensor data comprises information about a surrounding environment of the vehicle;
transmit sensor data comprising information about the surrounding environment of the vehicle to a remote system;
obtain off-board processed data from the remote system, the off-board processed data being indicative of a supplementary world-view of the ADS;
form an augmented world-view of the ADS based on the generated local world-view and the supplementary world-view;
generate, at an output, a signal indicative of the augmented world-view of the ADS.

23. A ground vehicle comprising:
at least one sensor configured to monitor a surrounding environment of the vehicle;
at least one communication device for transmitting/receiving wireless signals to/from a remote system via a communication network;
an in-vehicle system for augmenting capabilities of an Automated Driving System (ADS) of a vehicle, the in-vehicle system comprising a control circuitry configured to:
locally process, using a perception module, sensor data obtained from one or more sensors of the vehicle in order to generate a local world-view of the ADS, wherein the sensor data comprises information about a surrounding environment of the vehicle;
transmit sensor data comprising information about the surrounding environment of the vehicle to a remote system;
obtain off-board processed data from the remote system, the off-board processed data being indicative of a supplementary world-view of the ADS;
form an augmented world-view of the ADS based on the generated local world-view and the supplementary world-view; and
generate, at an output, a signal indicative of the augmented world-view of the ADS.
